(19) United States
(12) Patent Application Publication
(10) Pub. No.: US 2010/0174556 A1
(43) Pub. Date: Jul. 8, 2010

(54) METHOD AND APPARATUS FOR FACILITATING PROVIDER PAYMENT

(75) Inventors: Alec S. Wilkins, Salt Lake City, UT (US); Jennifer W. Vanderwall, Wilton, CT (US); Susan Riskovosky, O'Fallon, MO (US)

Correspondence Address: RYAN, MASON & LEWIS, LLP, 1300 POST ROAD, SUITE 205, FAIRFIELD, CT, 06824, US

(73) Assignee: MasterCard International Incorporated, Purchase, NY (US)

(21) Appl. No.: 12/582,152

(22) Filed: Oct. 20, 2009

Related U.S. Application Data
(60) Provisional application No. 61/106,991, filed on Oct. 21, 2008.

(51) Int. Cl. G06Q 30/00; G06Q 50/00; G06Q 20/00; G06F 15/16

(52) U.S. Cl. 705/3; 705/40; 709/206

(57) ABSTRACT

Authorization, clearing and settlement are facilitated for a pre-payment portion of a transaction conducted with a provider using a payment device having an account number. Adjudication of a claim pertaining to the transaction is facilitated, resulting in a payer portion and a remaining patient portion. Storage of transaction information pertaining to the transaction, by an issuer of the payment device, is facilitated, as is matching, by the issuer of the payment device, of: (i) a payment advice associated with the adjudication of the claim with (ii) the transaction information stored in the step of facilitating storage. In some instances, responsive to the matching, an additional step includes facilitating the issuer controlling initiation of authorization, clearing, and settlement of the remaining patient portion. In addition to or in lieu of the additional step, the step facilitating the issuer communicating with a holder of the payment device to offer the holder an opportunity for opt-out, prior to settlement of the remaining patient portion, may be carried out.

### CROSS-REFERENCE TO RELATED APPLICATION(S)

This application claims the benefit of U.S. Provisional Application Ser. No. 61/106,991, filed on Oct. 21, 2008, the complete disclosure of which is expressly incorporated herein by reference in its entirety for all purposes.

### FIELD OF THE INVENTION

The invention relates generally to electronic commerce, and, more particularly, to electronic payment systems.

### BACKGROUND OF THE INVENTION

Healthcare providers (e.g., hospitals, physician offices) may provide products and services to patients, for which the price is not pre-determined and for which a third party (e.g., health plan, third party administrator (TPA), etc.) must ascertain the price. Once the healthcare claim has been adjudicated and the prices of services are finalized, the healthcare provider is notified of the amount owed by the patient. The provider then must invoice the patient for the amount owed. As a result of the delay in billing, providers face an increasing collections and bad-debt problem.

Currently, providers may keep the card number of a payment card of the patient on file, to prevent bad debts (although this may me inappropriate under one or more applicable payment network rules). In another current approach, providers may bill only after services have been provided and the price has been ascertained.

US Patent Publication 2003/0200118 of Lee et al. discloses a system and method for payment of medical claims. The system allows a health care provider to arrange payment at the time of service for a patient responsibility portion of a health care claim amount, even though the provider may not know what the patient responsibility portion will be until after adjudication. A health care debit card is associated with an account of the patient. At the time of service, the patient presents the card to the provider. The provider uses the card to authorize the system to hold an estimate of the patient responsibility amount in suspense in the patient's account. After adjudication, when the actual patient responsibility amount is known, a transaction set is sent to the system. The system then automatically transfers the actual patient responsibility amount from the patent's account and into the provider's bank account. Any remainder of the suspended funds is left in the patient's account. A trace number is provided so that the provider can reconcile bank statement deposits with transaction set information.

### SUMMARY OF THE INVENTION

Principles of the invention provide techniques for facilitating provider payment. An exemplary embodiment of a method (which can be computer-implemented), according to one aspect of the invention, includes the steps of facilitating authorization, clearing and settlement for a pre-payment portion of a transaction conducted with a provider using a payment device having an account number; facilitating adjudication of a claim pertaining to the transaction, the adjudication resulting in a payer portion and a remaining patient portion; and facilitating storage of transaction information pertaining to the transaction, by an issuer of the payment device. Also included are facilitating matching, by the issuer of the payment device, of: (i) a payment advice associated with the adjudication of the claim with (ii) the transaction information stored in the step of facilitating storage; and, responsive to the matching, facilitating the issuer controlling initiation of authorization, clearing, and settlement of the remaining patient portion.

In another aspect, exemplary embodiment of a method (which can be computer-implemented), includes the steps of facilitating authorization, clearing and settlement for a pre-payment portion of a transaction conducted with a provider using a payment device having an account number; facilitating adjudication of a claim pertaining to the transaction, the adjudication resulting in a payer portion and a remaining patient portion; and facilitating storage of transaction information pertaining to the transaction, by an issuer of the payment device. Also included are facilitating matching, by the issuer of the payment device, of: (i) a payment advice associated with the adjudication of the claim with (ii) the transaction information stored in the step of facilitating storage; and, responsive to the matching, facilitating the issuer communicating with a holder of the payment device to offer the holder an opportunity for opt-out, prior to settlement of the remaining patient portion.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

One or more embodiments of the invention can provide substantial beneficial technical effects; for example, increased transactional security, increased accuracy and precision in payment data.

These and other features and advantages of the invention will become apparent from the following detailed description of illustrative embodiments thereof, which is to be read in connection with the accompanying drawings.

### BRIEF DESCRIPTION OF THE DRAWINGS

FIG. 1 shows an example of a system that can implement techniques of the invention;

FIG. 2 shows a combined flow chart and block diagram, illustrative of data flow in a first exemplary embodiment of a method and system, according to an aspect of the invention;

FIG. 3 shows a combined flow chart and block diagram, illustrative of data flow in a second exemplary embodiment of a method and system, according to another aspect of the invention;

FIG. 4 shows a combined flow chart and block diagram, illustrative of data flow in a third exemplary embodiment of a method and system, according to still another aspect of the invention;

FIG. 5 is a block diagram of an exemplary computer system useful in one or more embodiments of the invention;

FIG. 6 depicts exemplary software architecture; and

FIG. 7 depicts an exemplary inter-relationship between and among: (i) a payment network configured to facilitate transactions between multiple issuers and multiple acquirers, (ii) a plurality of users, (iii) a plurality of providers or other merchants, (iv) a plurality of acquirers, and (v) a plurality of issuers.

### DETAILED DESCRIPTION OF PREFERRED EMBODIMENTS

One or more embodiments of the invention provide a system, method, and/or computer program product which expedite payment for healthcare providers and reduce post-service billing and collection efforts. Unique messaging and supplemental transactions enable payers, issuers, and/or third parties to notify, and subsequently trigger payments to, healthcare providers. In one or more instances, notification and payment can be initiated immediately following the adjudication of the claim. By way of example and not limitation, three illustrative embodiments are presented herein, namely, a first “message only” embodiment, a second “message+authorization” embodiment, and a third “message+clearing and settlement” embodiment.

One or more embodiments include new network messaging and new transactions which enable communication of the amounts owed and provide merchants and/or providers with a payment vehicle with which they may collect the outstanding balance. The new healthcare message is designed to communicate the finalized status and amount owed by patients. The message contains sufficient information to allow the provider to determine the patient, claim and encounter for which he or she is to receive payment.

In the “message only” embodiment, a non-financial message notifies providers of the final patient responsibility. The message may also provide a unique one-time use card number which the provider uses to initiate a secondary transaction to authorize, clear and settle the remaining patient liability.

In the “message+authorization” embodiment, the techniques of the first embodiment are employed, but further communication to the provider includes an indication that the amount communicated in the network message had been previously authorized by the issuer. This eliminates the need for the provider to authorize the particular transaction.

In the “message+clearing and settlement” embodiment, the techniques of the first and second embodiments are employed, but further functionality allows the payer, issuer or third-party to trigger clearing and settlement activities on the network. This eliminates any further action by the provider. The network message provides sufficient information to facilitate reconciliation and accounting, and the payment is processed on a payment network and deposited (via the merchant acquirer) to the provider's account. Examples of the payment network include those of the kind configured to facilitate transactions between multiple issuers and multiple acquirers; for example, the BANKNET® network of MasterCard International Incorporated, or the VISANET® network of Visa International Service Association. The supplemental transaction message will utilize one or more of the current standard message formats with the inclusion of new data elements. For example, ISO 8583 MTI 1220, 1230, 1240 or 1740 clearing and settlement messages may be employed, and an ISO 8583 MTI 0120 “auth” message may be employed for notification. An example of a new function code is one identifying the transaction as an “autopay” transaction. Examples of new data elements include a payer identifier (payer ID), patient identifier (patient ID), and a claim identifier (claim ID—for example, a number or alphanumeric string assigned to the particular claim). The aforementioned payment network may be configured in accordance with a payment system standard and/or specification.

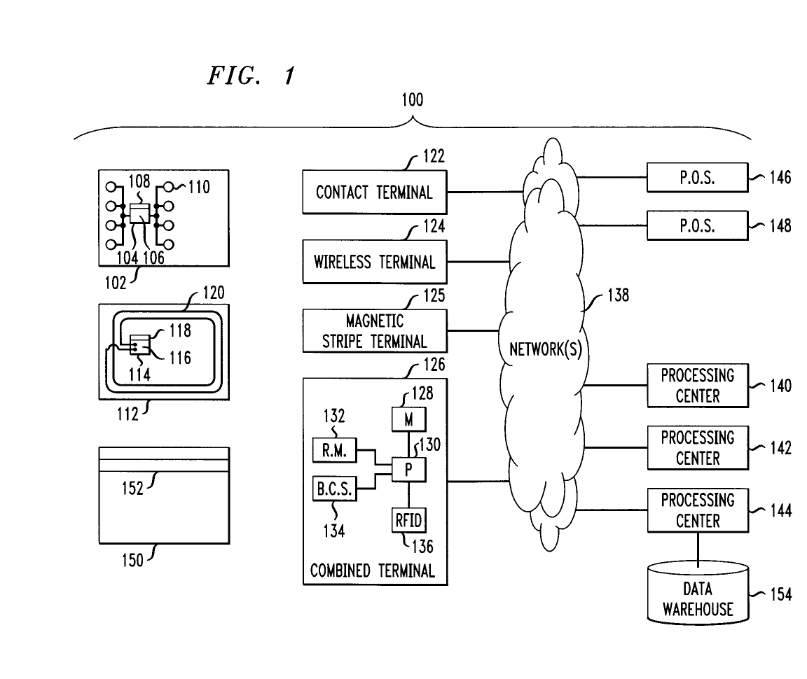

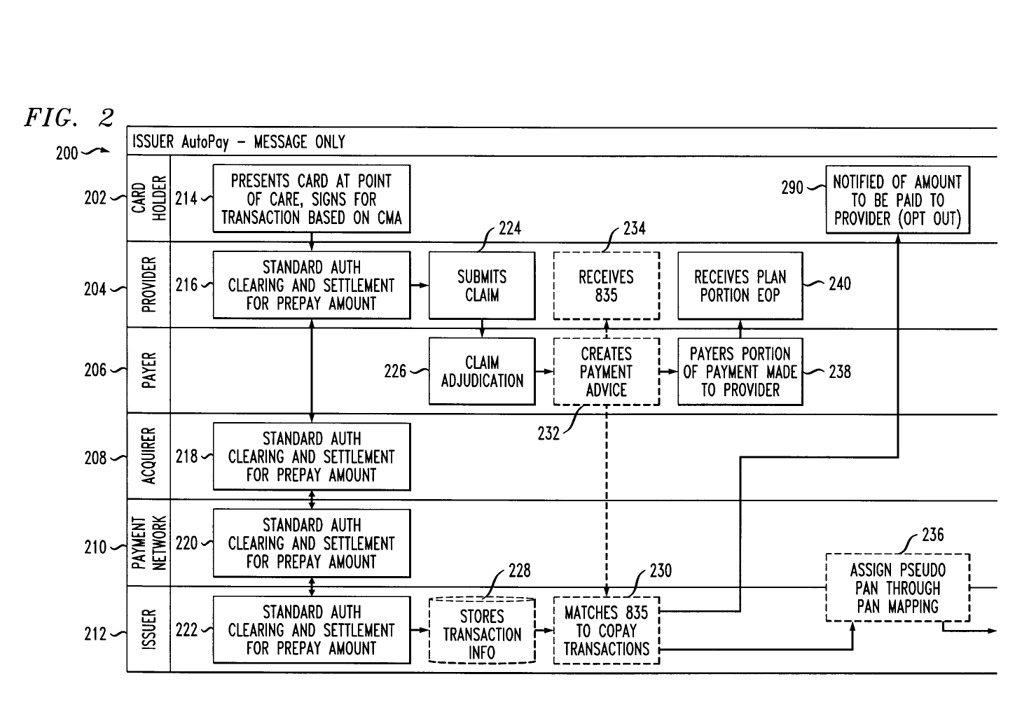

Attention should now be given to FIG. 1, which depicts an exemplary embodiment of a system 100, according to an aspect of the invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed with techniques of the invention. Other types of devices could include a conventional card 150 having a magnetic stripe 152, an appropriately configured cellular telephone handset, and the like. Indeed, techniques of the invention can be adapted to a variety of different types of cards, terminals, and other devices, configured, for example, according to a payment system standard (and/or specification).

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions or units 108, 118 can store the operating system of the cards 102, 112. The operating system loads and executes applications and provides file management or other basic card services to the applications. One operating system that can be used to implement the invention is the MULTOS® operating system licensed by StepNexus Inc. Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible standard to which such applications may conform is the EMV payment standard set forth by EMVCo, LLC (901 Metro Center Boulevard, Mailstop M3-3D, Foster City, Calif., 94404, USA). It will be appreciated that, strictly speaking, the EMV standard defines the behavior of a terminal; however, the card can be configured to conform to such EMV-compliant terminal behavior and in this sense is itself EMV-compliant. It will also be appreciated that applications in accordance with the invention can be configured in a variety of different ways.

In some instances, implementations may conform to appropriate healthcare payment card standards set forth by the Workgroup for Electronic Data Interchange, 12020 Sunrise Valley Drive, Suite 100, Reston, Va. 20191. In some cases, implementations conform to pertinent ISO standards, such as ISO 8583. Individual entities or groups may develop specifications within this standard. Some messages (for example, authorization request and response) are defined within ISO 8583, while the new messages mentioned herein may be implemented by the skilled artisan, given the teachings herein, for example, by using one or more current standard message formats with the inclusion of new data elements, and/or as part of a specification conforming to the ISO 8583 standard.

As noted, cards 102, 112 are examples of a variety of payment devices that can be employed with techniques of the invention. The primary function of the payment devices may not be payment, for example, they may be cellular phone handsets that implement techniques of the invention. Such devices could include cards having a conventional form factor, smaller or larger cards, cards of different shape, key fobs, personal digital assistants (PDAs), appropriately configured cell phone handsets, or indeed any device with the capabilities to implement techniques of the invention. The cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to facilitate execution of one or more method steps. The applications can be, for example, application identifiers (AIDs) linked to software code in the form of firmware plus data in a card memory such as an electrically erasable programmable read-only memory (EEPROM). Again, note that “smart” cards are not necessarily required and a magnetic stripe card can be employed.

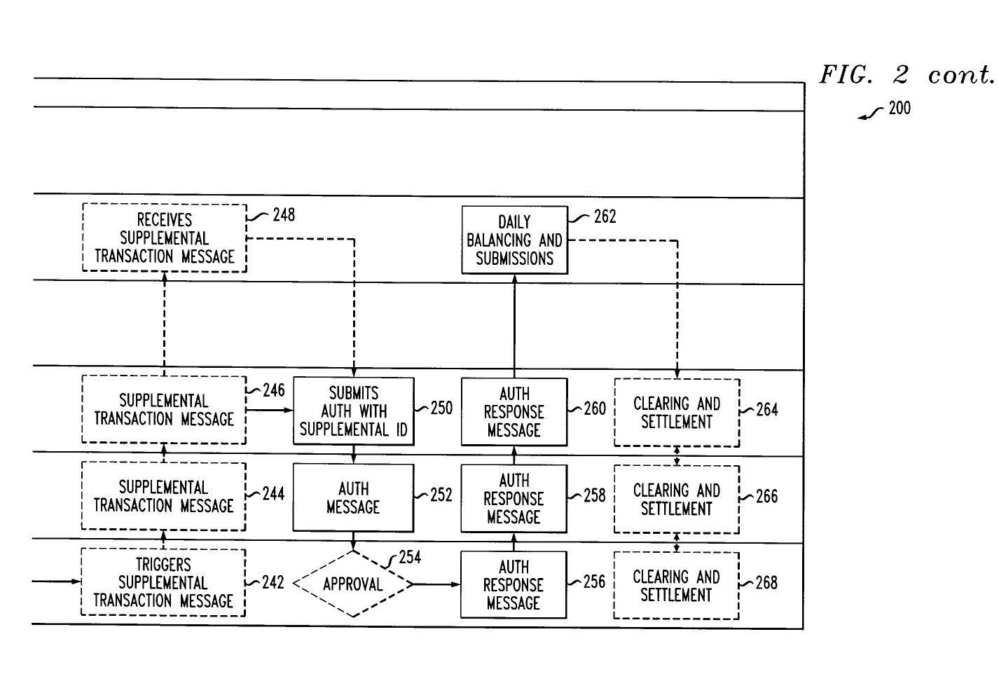

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (for example, a virtual private network, such as the aforementioned BANKNET® network. More than one network could be employed to connect different elements of the system. Processing centers 140, 142, 144 can include, for example, a host computer of an issuer of a payment device (or processing functionality of other entities discussed in FIGS. 2-4 herein).

Many different retail or other establishments, represented by points-of-sale 146, 148, can be connected to network 138. Each such establishment can have one or more terminals. Further, different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed.

The portable device can include a body portion. For example, this could be a laminated plastic body (as discussed above) in the case of “smart” cards 102, 112, or the handset chassis and body in the case of a cellular telephone.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. In some instances, the aforementioned bar code scanner 134 and/or RFID tag reader 136 can be provided, and can be coupled to the processor, to gather data, such as a product identification, from a UPC code or RFID tag on a product to be purchased.

The above-described devices 102, 112 can be ISO 7816-compliant contact cards or devices or ISO 14443-compliant proximity cards or devices. In operation, card 112 can be touched or tapped on the terminal 124 or 126, which then contactlessly transmits the electronic data to the proximity IC chip in the card 112 or other wireless device. Magnetic stripe cards can be swiped in a well-known manner.

One or more of the processing centers 140, 142, 144 can include a database such as a data warehouse 154 for storing information of interest. In the context of one or more embodiments of the invention, such as those depicted in FIGS. 2-4, card holder 202 could hold a device such as 102, 122, 150; provider 204 could have a terminal such as 122, 124, 125, 126, and the entities 206, 208, 210, 212 could operate processing centers such as 140, 142, 144 (with data storage 154 as needed). Network(s) 138 could, as noted, include a virtual private network (VPN) and/or the Internet; the VPN could be, for example, the aforementioned BANKNET® network, and entity 210 could be, for example, an entity such as MasterCard International Incorporated, Purchase, N.Y., USA.

FIG. 2 shows a combined flow chart and block diagram 200, illustrative of data flow in the aforementioned first “message only” exemplary embodiment of a method and system, according to an aspect of the invention. Recall that in this embodiment, a non-financial message notifies providers of the final patient responsibility (see discussion of supplemental transaction message in blocks 244, 246, and 248 below). Furthermore, a unique one-time use card number may be provided (see discussion of block 236 below) which the provider may use to initiate a secondary (supplemental) transaction to authorize, clear and settle the remaining patient liability.

As indicated in block 214, card holder 202 presents the card (or other payment device) to provider 204 at the point of care, and signs for the transaction based on the Card Member Agreement (CMA; the agreement between the issuer and the card holder governing terms of use). As shown at blocks 216, 218, 220 and 222, provider 204 initiates a standard authorization, clearing and settlement for the pre-pay amount, via acquirer 208, payment network 210, and issuer 212. As indicated at block 224, provider 204 submits a claim to payer 206 for adjudication in block 226. Payer 206 creates an “835” message or other payment advice in block 232. The provider 204 receives the “835” message or other payment advice in block 234, while the issuer 212 matches the “835” message or other payment advice to the pre-pay transaction(s) in block 230, such transactions having been stored in block 228. Payer 206 makes its portion of the payment (the plan portion) to the provider 204 in block 238, while the provider receives same in block 240, together with the explanation of payments (EOP). or the Electronic Remittance Advice (ERA). Note that in the ANSI ASC X12 messaging standard for Health Care Claim Payment/Advice, the “835” message is the standard message used to communicate adjudication details of a healthcare claim; it is typically a response to an X12 “837” Healthcare Claim. The “835” message is one option, which may be created by the payer 206, to notify the provider 204 of the amounts being paid, from a payer perspective, and also to notify the provider of any remaining amounts due from the patient.

In block 290, issuer 212 has notified the card holder 202 of the amount to be paid to the provider, thus affording the card holder an opportunity to “opt out” or object if the amount does not appear to be correct.

In block 236, issuer 212 and/or network 210 assign a “pseudo PAN” via PAN mapping (discussed further below). A supplemental transaction message is triggered in block 242; as indicated at blocks 244, 246, and 248, such message is communicated to provider 208 via network 210 and acquirer 208. In block 250, acquirer 208 submits an authorization request with a supplemental identifier (ID). With regard to the dotted lines interconnecting blocks 246, 248, 250, note that, depending on the level of participation from the acquirer, in some instances, the provider initiates the auth in block 250, while in other cases, the acquirer does this. As shown at block 252, the authorization message passes from acquirer 208 to issuer 212 for approval in block 254; the resulting authorization response message is sent from issuer 212 to provider 204 via network 210 and acquirer 208, as shown at blocks 256, 258, and 260, for periodic (by way of example and not limitation, daily) balancing and submissions, as at block 262. Following same, clearing and settlement for the supplemental transaction follows via messaging through the acquirer, network, and issuer, as shown at blocks 264, 266, 268, resulting in the provider being paid, and the card holder's account being debited for, the remaining patient liability (i.e., the total adjudicated amount less pre-pay and payer's portion previously paid).

The aforementioned PAN mapping can be, for example, a network service that an operator of a payment network (e.g., an entity such as MasterCard International Incorporated) provides to issuers; in other instances, issuers may elect to use their own solution. The PAN mapping process involves taking the original Primary Account Number (PAN) and issuing a pseudo-PAN (or virtual card number) in its place. This provides security against the possibility of the original PAN becoming compromised. This is of value to healthcare providers and patients because the provider's office staff would not have access to the actual account. A non-limiting example of PAN mapping is that offered under the “one time use number” feature of MasterCard International Incorporated's in Control™ payment solutions platform. The skilled artisan will be familiar with a variety of PAN mapping techniques, and, given the teachings herein, will be able to adapt same to one or more embodiments of the invention. For example, the payment network operator may create a translation table wherein external-facing instances of the number present the pseudo-PAN while internal-facing instances present the actual PAN. Commercially available PAN-mapping solutions which may be adapted to embodiments of the invention, given the teachings herein, include those available from Orbiscom Ltd., Block 1, Blackrock Business Park, Carysfort Avenue, Blackrock, Co. Dublin, Ireland; by way of example and not limitation, techniques of U.S. Pat. Nos. 6,636,833 and 7,136,835 of Flitcroft et al., the complete disclosures of both of which are expressly incorporated herein by reference in their entireties for all purposes.

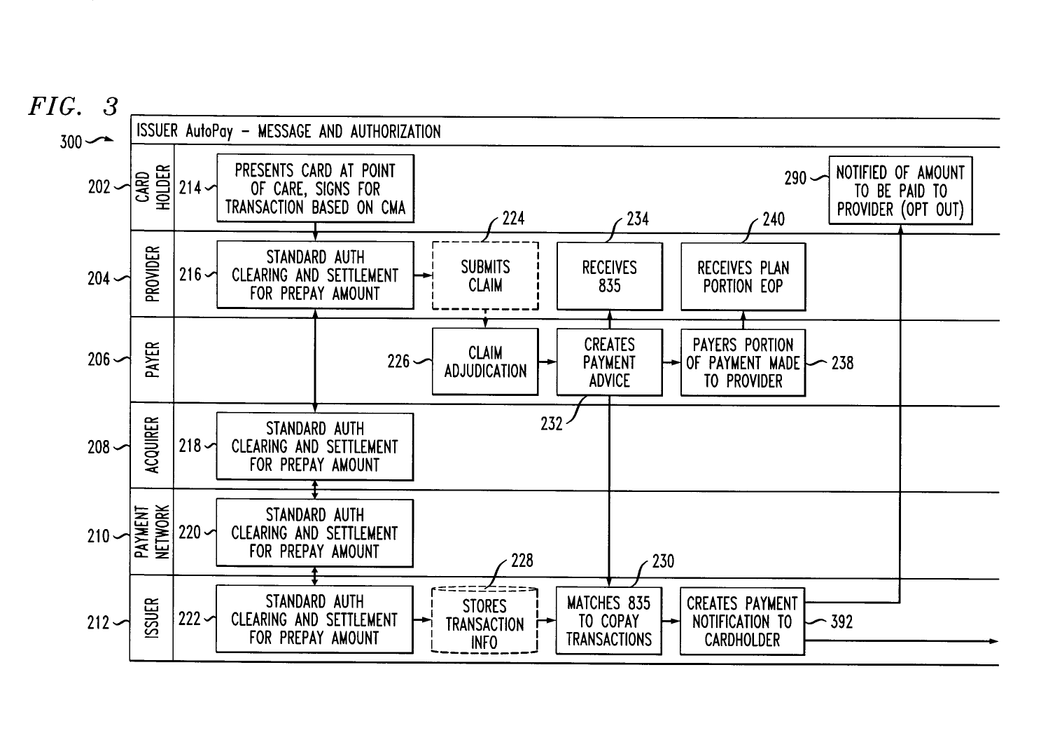

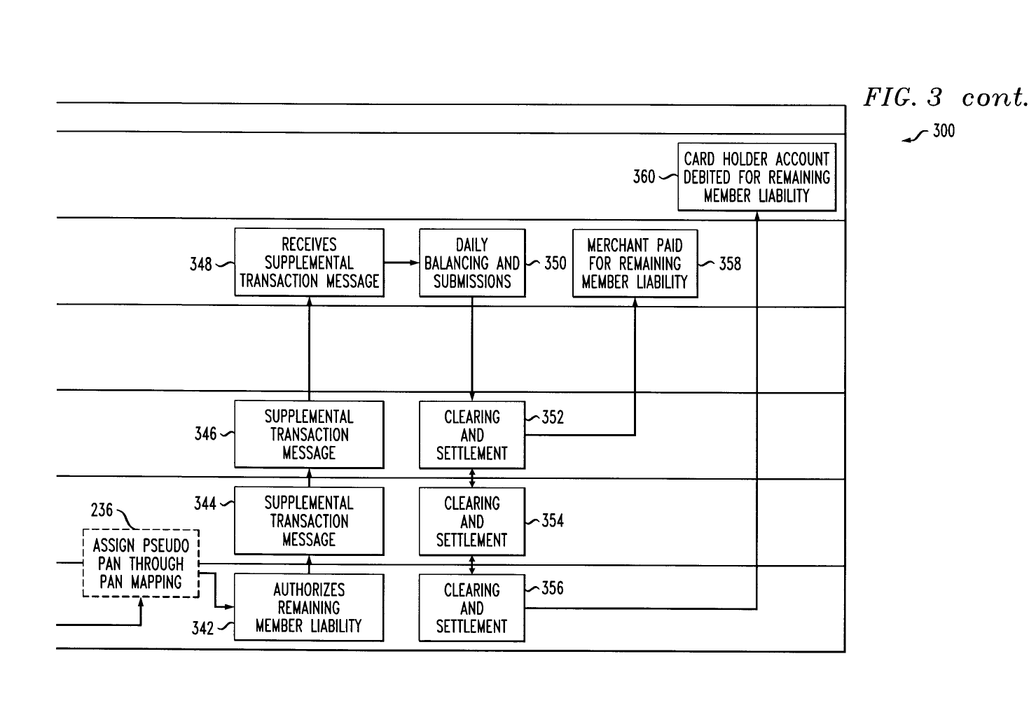

FIG. 3 shows a combined flow chart and block diagram 300, illustrative of data flow in the aforementioned second “message+authorization” exemplary embodiment of a method and system, according to another aspect of the invention. Recall that in this approach, the techniques of the first embodiment are employed, but further communication to the provider includes an indication that the amount communicated in the network message had been previously authorized by the issuer (see discussion of block 342 below). This eliminates the need for the provider to authorize the particular transaction.

Blocks 202 through 240 are similar to those in FIG. 2 and will not be described again. Note block 392, wherein issuer 212 creates a payment notification to card holder 202. Block 290 is similar to block 290 in FIG. 2. In block 342, issuer 212 authorizes the remaining member liability and dispatches a supplemental transaction message to provider 204 via network 210 and acquirer 208, as illustrated at blocks 344, 346. The provider 204 receives the supplemental transaction message at block 348 and carries out periodic (by way of example and not limitation, daily) balancing and submissions, as at block 350. Following same, clearing and settlement for the transaction follows via messaging through the acquirer, network, and issuer, as shown at blocks 352, 354, and 356. At block 358, the provider is paid for the remaining member liability. At block 360, the cardholder account is debited for the remaining member liability.

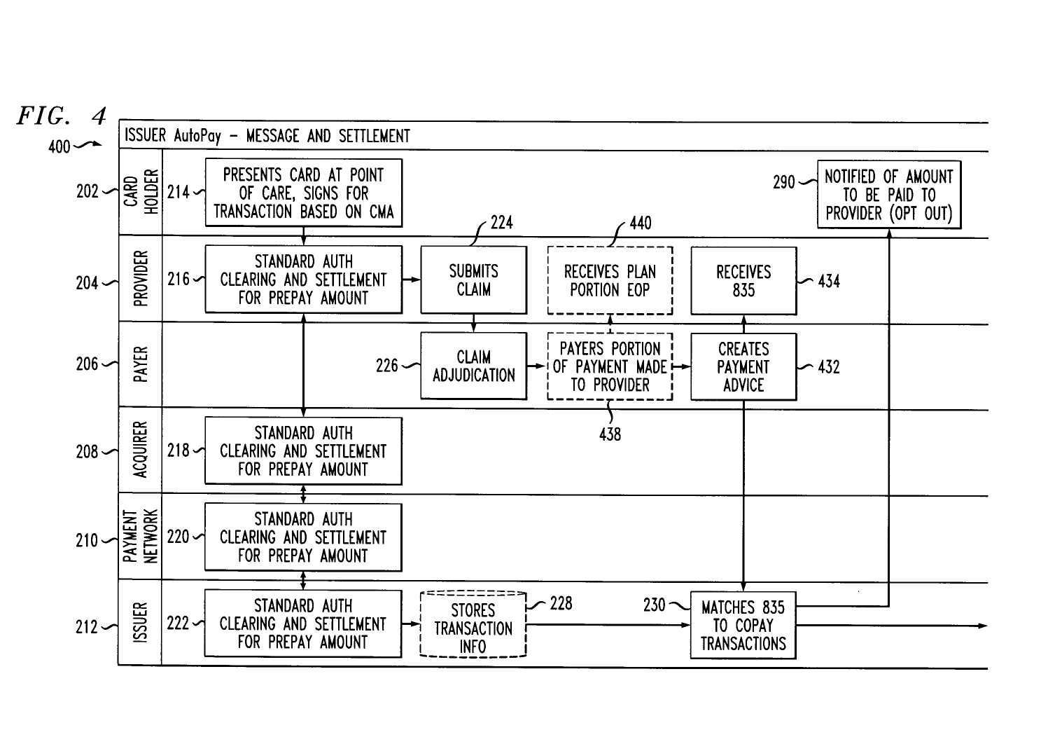

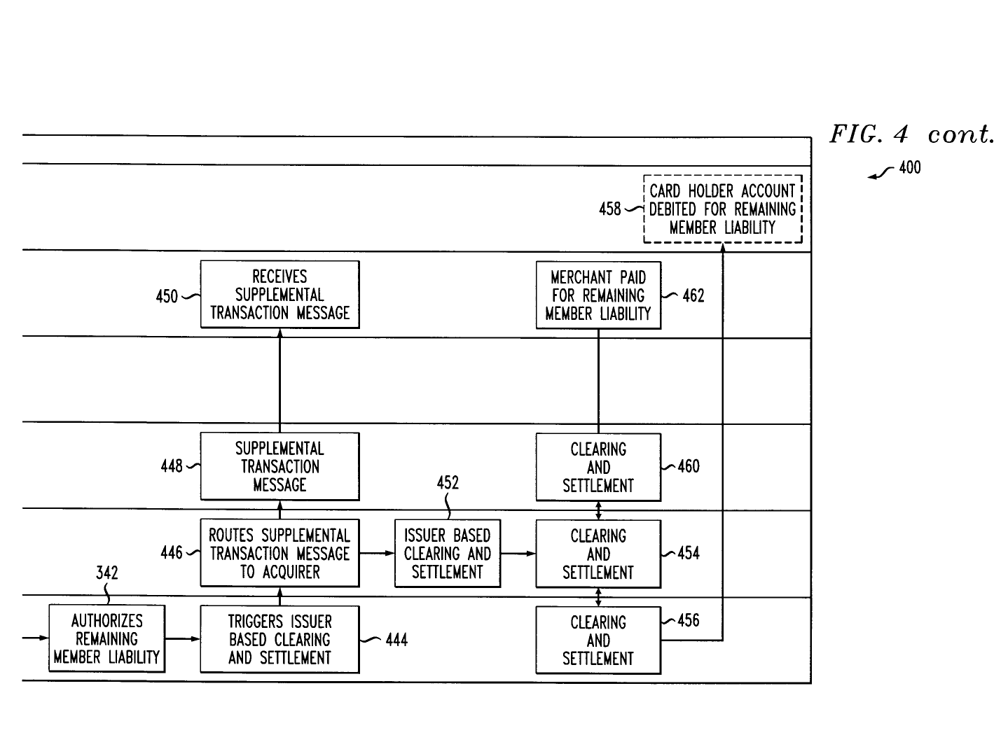

FIG. 4 shows a combined flow chart and block diagram 400, illustrative of data flow in the aforementioned third “message+clearing and settlement” exemplary embodiment of a method and system, according to yet another aspect of the invention. In this aspect, certain techniques of the first and second embodiments are employed, but further functionality allows the payer, issuer or third-party to trigger clearing and settlement activities on the network (see block 452 below). This eliminates any need for further action by the provider. The network message provides sufficient information to facilitate reconciliation and accounting, and the payment is processed on a payment network and deposited (via the acquirer 208) to the provider's account.

Note that within the context of FIG. 4, block 212 broadly represents an issuer, an issuer processor, and/or other third party processor who may carry out one or more of the indicated steps. In general, third parties may include issuer processors and third-party administrators or other service providers providing service to issuers or payers.

Blocks 202 through 228 are similar to those in FIG. 2 and will not be described again. Following adjudication of the claim in block 226, in block 438, payer 206 makes its portion of the payment to the provider 204, who receives the plan portion EOP in block 440. In block 432, payer 206 creates a payment advice (e.g., “835” message), which is received by provider 204 in block 434. Blocks 230 and 290 are similar to those in FIG. 2. In the example of FIG. 4, processing flow for issuer 212 proceeds from step 230 to step 342 (step 342 is described above with regard to FIG. 3); step 236 is omitted in at least some cases. The authorization in step 342 triggers issuer based clearing and settlement in block 444. Network 210 routes a supplemental transaction message to acquirer 208 as shown in blocks 446, 448; this message is received by provider 204 in block 450. Network 210 facilitates the issuer based clearing and settlement, as shown at block 452; interaction of network 210 with issuer 212 and acquirer 208, as depicted in blocks 454, 456, 460, results in the merchant (provider 204) being paid for the remaining member liability, at block 462, as well as the card holder account being debited for the remaining member liability, in block 458. Note that in this embodiment, in general, the pseudo-PAN may or may not be used; however, it is presently believed likely that it would not be needed as the transaction is complete by the time it is received by the merchant.

In a number of current techniques, all transactions originate at the merchant or the acquirer. It is necessary to wait until the merchant knows what he or she is owed, and then, payment can be triggered. In one or more embodiments of the invention, the issuer is able to trigger payment. In a traditional card transaction, the merchant is the party who first knows the cost of the goods or services, and it is the merchant who, through the acquirer, submits a request for payment and is then paid through the process of clearing and settlement. In one or more embodiments of the invention, particular issuers know in advance of the merchant(s) the amounts that the patients owe the merchant(s). In order to expedite the payment, in one or more embodiments, the transaction is re-sequenced and the issuer is allowed to essentially push the payment to the provider.

Potential advantages of one or more embodiments of the invention include (i) expedited payment, since the issuer knows of the amount before the merchant; as well as (ii) an inherent advantage to health care issuers who are subject to substantiation requirements by the Internal Revenue Service (IRS). There is substantial expense associated with manually substantiating transactions. In order to mitigate such expenses, in one or more embodiments, these issuers receive feeds from the payer advising them what services and goods were received so that they may auto-substantiate the transaction prior to the transaction per se. The issuer is in control of the transaction timing and may control the process such that they only execute transactions that they have already auto-substantiated.

Furthermore, in certain current techniques, once the patient leaves the provider's office, he or she has no further control over the transaction. In one or more embodiments of the invention, because of the issuer's relationship with the consumer (patient), the issuer, when they receive the “835” message, prior to triggering the transaction and pushing money to the acquirer, contacts the patient and advises the patient of the proposed time and amount of payment, thus allowing a “touch point” with the consumer.

With attention again to blocks 444-456, in block 444, a modified 1240 or 1740 message is sent by the issuer to the payment network to trigger clearing and settlement. Block 446 represents a routing step and in block 452, the payment network takes in the modified 1240 or 1740 message, and from that, triggers “business as usual” clearing and settlement at blocks 454, 456, 458, 460 and 462.

### Exemplary Message Layouts

Note that words such as “should,” “must,” “shall,” “may,” and the like, are in the context of this non-limiting example, and other embodiments of the invention may differ; for example, something mandatory in this example might be optional in another embodiment. In one or more embodiments, the supplemental transaction message for post-adjudication payment of the remaining patient-responsible balance should include the following data elements. These are needed, in one or more embodiments, to pass to the acquirer and/or provider to ensure accurate posting against the patient account at the provider location. “ID” means “identifier.”
1. Patient Account/ID
2. Provider Account/ID
3. Claim Number
4. Payment Network (for example, BANKNET network or VISANET network) Reference Number from original ‘co-pay’ transaction

The following identify exemplary preferred message layouts and usage for various exemplary embodiments.

Fee Collection (Other than Retrieval Fee Billing/Handling Fees)/1740 Message Layout

One or more embodiments employ the message type indicator (MTI) 1740 from the ISO 8583 specification for card transactions. “DE” stands for data element. Given the teachings herein, the skilled artisan will be able to modify the basic MTI 1740 message to implement one or more embodiments of the invention.

In one or more embodiments, both the payment network and members use this message layout for fee collections other than retrieval fee billing or handling fees. For this message layout, in the exemplary embodiment:
1. The MTI must be 1740.
2. DE24 (Function Code) has three bits and specifies, together with DE25, that the particular 1740 message is for the post-adjudication payment of the patient-responsible balance.
3. DE25 (Message Reason Code) has four bits and specifies, together with DE25, that the particular 1740 message is for the post-adjudication payment of the patient-responsible balance.

In one or more embodiments, the following new data elements are added to the existing 1740 message format. This material can be included in any sub-element or data element, as desired.

Healthcare Payer ID
Healthcare patient ID/Patient Account
Healthcare Claim number
Healthcare Previous Payment Network Reference Number

For cases where the supplemental transaction message is for notification only, any of MTIs 0120, 0620, 0100, and 0110 can be employed, with MTI 0620 presently believed preferable.

In one or more embodiments, the following new data elements are added as subfields to DE48

Healthcare Payer ID
Healthcare patient ID/Patient Account
Healthcare Claim number
Healthcare Previous Payment Network Reference Number

The ISO 8583 Standard for Financial Transaction Card Originated Messages—Interchange message specifications is the International Organization for Standardization standard for systems that exchange electronic transactions made by cardholders using payment cards, all versions of which, including the 1987, 1993, and 2003 versions, are expressly incorporated herein by reference in their entirety for all purposes. Section 4.1.3.8, Fee Collection Message Class, of ISO 8583: 1993 (E), indicates that fee collection messages are used to collect or disburse miscellaneous service fees and that all fee collection messages shall use the 17xx message series. It further indicates that, for all fee collection messages:
1. Fee collection messages may be in either direction; acquirer to card issuer or card issuer to acquirer.
2. A fee collection message shall not be declined by the receiver except for specific defined reasons.
3. Fee collection messages have a financial impact and affect reconciliation totals. They shall not affect a cardholder account.
4. To cancel, either partially or completely, a previous fee collection transaction that was submitted in error, a subsequent fee collection transaction shall be sent using function code 701.

### Exemplary Software Architecture

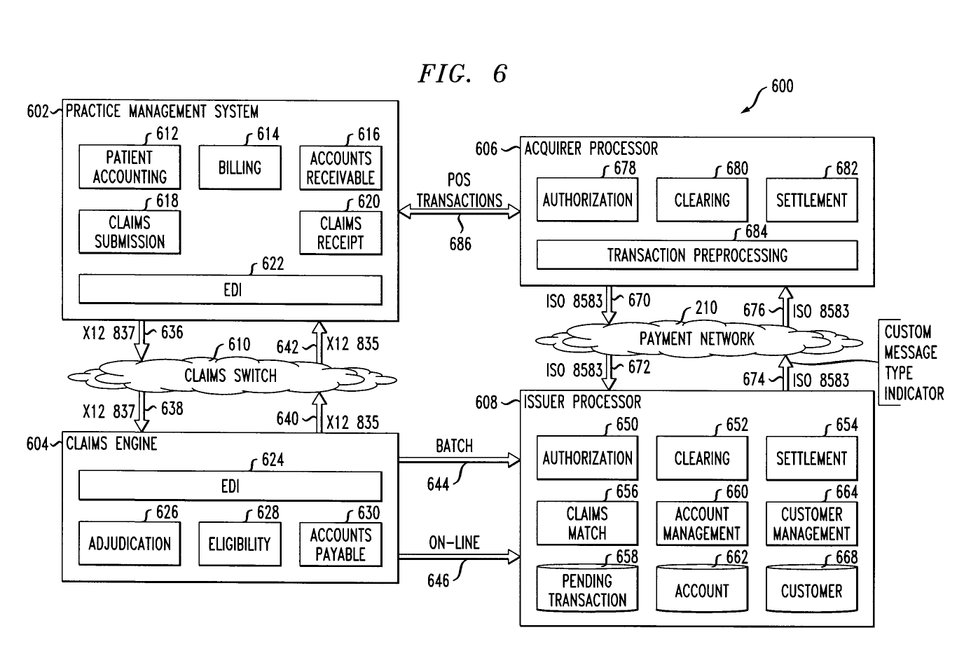

FIG. 6 depicts a non-limiting exemplary software architecture 600 that can be employed in one or more embodiments of the invention. Broadly included are a practice management system 602 of provider 204; a claims engine 604, operated, for example, by payer 206; an issuer processor platform 608, operated by issuer 212 or an issuer processor operating under the issuer's direction; and an acquirer processor platform 606 operated by acquirer 208 or an acquirer processor operating under the acquirer's direction. The issuer platform 608 and acquirer platform 606 are interconnected by payment network 210. Claims switch 610 provides an interface between practice management system 602 and claims engine 604. It may include, for example, a suitable network connection (e.g., Internet, virtual private network, and the like) with appropriate interface software residing in communication with system 602 and engine 604.

System 602 includes patient accounting, billing, accounts receivable, claims submission, and claims receipt modules 612, 614, 616, 618, 620, respectively. Electronic Data Interchange (EDI) layers 622, 624 are preferably provided in system 602 and engine 604, to assist with the aforementioned interface via switch 610. Engine 604 may include, for example, adjudication module 626, eligibility module 628, and accounts payable module 630.

ASC X12 (ANSI ASC X12), the U.S. national standards body for the development and maintenance of EDI standards, has sponsored a number of X12-based EDI standards and X12 extensible markup language (XML) schemas for health care, insurance, government, transportation, finance, and the like. In some instances, messages from system 602 to engine 604, as indicated by arrows 636, 638, may include X12 type 837 “Health Care Claim” messages. Furthermore, in some instances, messages to system 602 from engine 604, as indicated by arrows 640, 642, may include X12 type 835 “Health Care Claim Payment/Advice” messages.

Claims engine 604 may carry out both batch (arrow 644) and on-line (arrow 646) communications with issuer platform 608. Issuer platform 608 can include, for example, authorization, clearing, and settlement functionality 650, 652, and 654. Claims match functionality 656 may interact with a pending transactions data store 658. Account management functionality 660 may interact with an account data store 662. Customer management functionality 664 may interact with a customer data store 668.

Issuer platform 608 may interact with acquirer platform 606 via payment network 210. As indicated by arrows 670, 672, 674, 676, ISO 8583 messaging may be employed, for example. As indicated by the notation adjacent arrow 674, a custom message type indicator may be employed; in another approach, as set forth above, a standard MTI can be employed with data elements to specify the nature of the message (e.g., post adjudication as discussed above). Acquirer platform 606 may include suitable authorization, clearing, and settlement functionality 678, 680, and 682, as well as a suitable transaction processing portion 684. Point-of-sale (POS) transaction information is communicated between system 602 and platform 606, as shown at 686.

### Exemplary Payment Network and Relationship Details

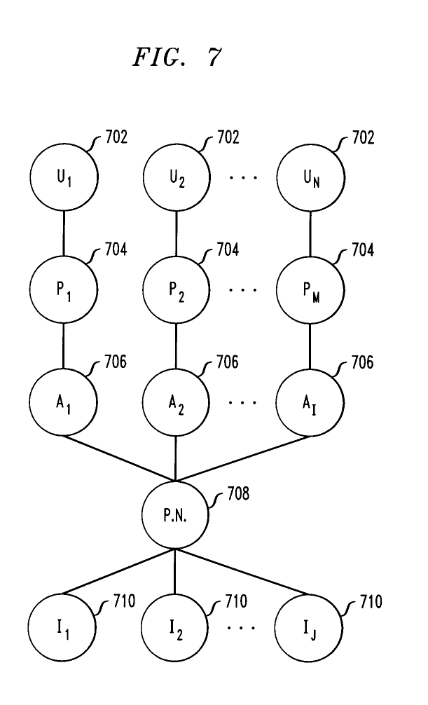

With reference to FIG. 7, an exemplary relationship among multiple entities is depicted. A number of different users 702, U₁, U₂ . . . U_{N}, interact with a number of different merchants 704, P₁, P₂ . . . P_{M}. In general, users 702 could be, for example, card holders, while merchants 704 could be, for example, health care providers. Merchants 704 interact with a number of different acquirers 706, A₁, A₂ . . . A_{I}. Acquirers 706 interact with a number of different issuers 710, I₁, I₂ . . . I_{J}, through, for example, a single operator 708 of a payment network (for example, network 210) configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional authorization process, the cardholder 702 pays for the purchase and the merchant 704 submits the transaction to the acquirer (acquiring bank) 706. The acquirer verifies the card number, the transaction type and the amount with the issuer 710 and reserves that amount of the cardholder's credit limit for the merchant. Authorized transactions are stored in “batches,” which are sent to the acquirer 706. During clearing and settlement, the acquirer sends the batch transactions through the credit card association, which debits the issuers 710 for payment and credits the acquirer 706. Once the acquirer 706 has been paid, the acquirer 706 pays the merchant 704.

It will be appreciated that the network 708 shown in FIG. 7 is an example of a payment network configured to facilitate transactions between multiple issuers and multiple acquirers, which may be thought of as an “open” system. Some embodiments of the invention may be employed with other kinds of payment networks, for example, proprietary or closed payments networks with only a single issuer and acquirer, such as the AMERICAN EXPRESS network (mark of American Express Company).

### Recapitulation

Thus, in view of the above discussion, it will be appreciated that, in general terms, an exemplary embodiment of a method, according to an aspect of the invention, includes the step of facilitating authorization, clearing and settlement for a pre-payment portion of a transaction conducted with a provider using a payment device having an account number, as shown, for example, at blocks 216-222. This step can be carried out, for example, using practice management system 602 communicating with acquirer 606, in turn communicating with issuer platform 608 over network 210. An additional step includes facilitating adjudication of a claim pertaining to the transaction, as per block 226. This may be carried out, for example, with adjudication functionality 626 in engine 604. The adjudication results in a payer portion paid in step 240 (using, for example, accounts payable functionality 630] and a remaining patient portion. Storage of transaction information pertaining to the transaction, by an issuer of the payment device, is facilitated as in block 228 (for example, in store 658). Matching, by the issuer of the payment device, of: (i) a payment advice associated with the adjudication of the claim with (ii) the transaction information stored in the step of facilitating storage, is facilitated in block 230 (for example, using functionality 656). Responsive to the matching, issuer control of initiation of authorization, clearing, and settlement of the remaining patient portion is facilitated, in one of a variety of ways, using, for example, functionality 650, 652, 654). In at least some instances, an additional step includes facilitating the issuer communicating with a holder of the payment device, as in block 290, to offer the holder an opportunity for opt-out, prior to the issuer initiating the authorization, clearing, and settlement of the remaining patient portion. This could be carried out, for example, based on information in customer data store 668.

In some cases, the issuer controlling the initiation includes assigning a pseudo account number (can be assigned, for example, by network 210 using a processor within the network 210 or by issuer 212 using platform 608) by mapping the account number, as per block 236, and facilitating the provider initiating a supplemental transaction, using the pseudo account number, to authorize, clear, and settle the remaining patient portion.

The step of facilitating the provider initiating the supplemental transaction may include, for example, sending the provider a supplemental transaction message including the pseudo account number, as at blocks 242, 244, 246, 248, using platform 608, network 210, and platform 606 communicating with system 602. Referring back to FIG. 2, the “835” message may be sent to issuer 212 (block 230) and provider 204 (block 234) and the sending thereof in block 232 could be at the same time, or, for example, the “835” message could be sent to the issuer first.

In some embodiments, the issuer controlling the initiation includes, responsive to the matching in block 230, facilitating assigning a pseudo account number by mapping the account number, as per block 236; and facilitating the issuer of the payment device initiating a supplemental transaction, using the pseudo account number, to authorize the remaining patient portion, as per block 342 (for example, using authorization functionality 650 of platform 608). As shown at blocks 344-348, an additional step can include sending the provider a supplemental transaction message including the pseudo account number and an indication that the remaining patient portion has already been authorized (for example, using authorization functionality 650 of platform 608, network 210, and platform 606 communicating with system 602).

In some instances, the issuer controlling the initiation includes, responsive to the matching, facilitating issuer-based clearing and settlement of the remaining patient portion, as per block 444 (for example, using clearing and settlement functionality 652, 654 of platform 608, network 210, and platform 606 optionally communicating with system 602). The issuer-based clearing and settlement of the remaining patient portion preferably occurs without any further action required by the provider.

By way of review and provision of additional detail, in the embodiment of FIG. 3, the “auth” message is already processed, and in the embodiment of FIG. 4, authorization, clearing and settlement are all automated. In the embodiment of FIG. 3, the issuer handles the “auth” and just notifies the provider that the amount is authorized. The embodiment of FIG. 4 may be even more powerful, in one or more applications, in that the provider is paid without needing to be active. A significant difference between the embodiments is that the merchant (provider) has an active role in the embodiments of FIGS. 2 and 3. Stated another way, if the provider does not act, he or she will not receive payment. In the embodiment of FIG. 4, the provider is paid automatically. In any embodiment, of course, a card holder opt-out step can be provided.

One or more embodiments of the invention may provide one or more of the following benefits: expedited provider payment, issuer cost reduction, and consumer transaction control. Furthermore, aspects of the invention allow issuers to brand the product as their own. That is, Issuer A may offer an “Issuer A” co-branded MasterCard® card and Issuer B may offer an “Issuer B” co-branded MasterCard® card. Payment network 210 may facilitate this type of issuer co-branding for a variety of issuers. MasterCard® brand cards are a non-limiting example. The services described herein may thus be rolled out to multiple co-branded issuers with a single processor (e.g., operator of network 210) in a syndication aspect. Stated in another way, in the issuer co-branding aspect, the steps described are repeated for one or more additional transaction conducted using one or more additional payment devices issued by one or more different issuers and carrying one or more different brands. The original and repeated steps are performed in association with a single payment network operator.

In another aspect, an exemplary embodiment of a method includes the step of facilitating authorization, clearing and settlement for a pre-payment portion of a transaction conducted with a provider using a payment device having an account number, as shown, for example, at blocks 216-222. An additional step includes facilitating adjudication of a claim pertaining to the transaction, as per block 226. The adjudication results in a payer portion paid in step 240 and a remaining patient portion. Storage of transaction information pertaining to the transaction, by an issuer of the payment device, is facilitated as in block 228. Matching, by the issuer of the payment device, of: (i) a payment advice associated with the adjudication of the claim, with (ii) the transaction information stored in the step of facilitating storage, is facilitated in block 230. Responsive to the matching, the issuer communicating with a holder of the payment device is facilitated. Such communication is made to offer the holder an opportunity for opt-out, prior to settlement of the remaining patient portion. These steps can be carried out, for example, using one or more elements in FIG. 6 as described above.

### System and Article of Manufacture Details

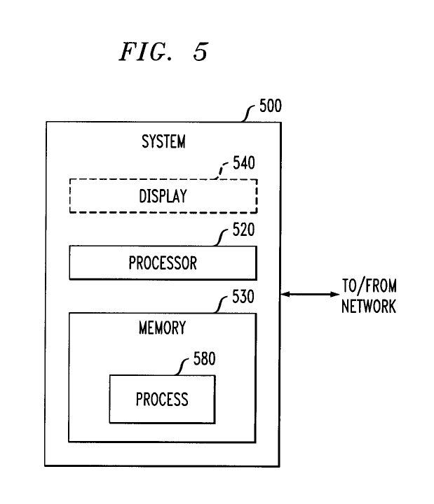

The invention can employ hardware and/or software aspects. Software includes but is not limited to firmware, resident software, microcode, etc. Software might be employed, for example, in connection with one or more of a terminal 122, 124, 125, 126; a processing center 140, 142, 144 (optionally with data warehouse 154) of a merchant, issuer, acquirer, processor, payment processing network operator, other entity as depicted in blocks 202-212 of FIGS. 2-4; and/or any of system 602, switch 610, engine 604, platform 608, and platform 606, and the like. Firmware might be employed, for example, in connection with payment devices such as cards 102, 112. FIG. 5 is a block diagram of a system 500 that can implement part or all of one or more aspects or processes of the invention. As shown in FIG. 5, memory 530 configures the processor 520 (which could correspond, e.g., to processor portions 106, 116, 130, processors of remote hosts in centers 140, 142, 144, processors associated with any entities as depicted in blocks 202-212 of FIGS. 2-4, processors of servers associated with platforms 606, 608, a servers or servers associated with engine 604, a server or personal computer associated with system 602, and the like) to implement one or more aspects of the methods, steps, and functions disclosed herein (collectively, shown as process 580 in FIG. 5). Different method steps can be performed by different processors. The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112). It should be noted that if distributed processors are employed, each distributed processor that makes up processor 520 generally contains its own addressable memory space. It should also be noted that some or all of computer system 500 can be incorporated into an application-specific or general-use integrated circuit. For example, one or more method steps could be implemented in hardware in an ASIC rather than using firmware. Display 540 is representative of a variety of possible input/output devices (e.g., displays, mice, keyboards, and the like).

As is known in the art, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may, in general, be a tangible computer-readable recordable storage medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium does not include a transmission medium or a disembodied signal.

The computer systems and servers described herein each contain a memory that will configure associated processors to implement the methods, steps, and functions disclosed herein. Such methods, steps, and functions can be carried out, e.g., by processing capability on elements 102, 112, 122, 124, 125, 126, 140, 142, 144, processors associated with any entities as depicted in blocks 202-212 of FIGS. 2-4, processors of servers associated with platforms 606, 608, a servers or servers associated with engine 604, a server or personal computer associated with system 602, and the like, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, the aforementioned terminals 122, 124, 125, 126; processing centers 140, 142, 144 with data warehouse 154; processors associated with any entities as depicted in blocks 202-212 of FIGS. 2-4; and the like, processors of servers associated with platforms 606, 608, a servers or servers associated with engine 604, a server or personal computer associated with system 602, or payment devices such as cards 102, 112; can make use of computer technology with appropriate instructions to implement method steps described herein. By way of further example, a terminal apparatus 122, 124, 125, 126 could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe).

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable storage medium. Further, one or more embodiments of the invention can include a computer comprising code adapted to cause the computer to carry out one or more steps of methods or claims set forth herein, together with one or more apparatus elements or features as depicted and described herein.

Thus, aspects of the invention can be implemented, for example, by one or more appropriately programmed general purpose computers, such as, for example, servers or personal computers, located at one or more of the locations 204, 206, 208, 212, as well as within network 210. Such computers can be interconnected, for example, by one or more of payment network 210, another VPN, the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the logic depicted in the flow charts of FIGS. 2-4. System 602 could be located at a provider's office; engine 604 could be located the facility of a payer or in communication therewith; platform 608 could be located at the facility of an issuer or issuer processor, and platform 606 could be located at the facility of an acquirer or acquirer processor, for example.

As used herein, including the claims, a “server” includes a physical data processing system (for example, system 500 as shown in FIG. 5) running a server program. It will be understood that such a physical server may or may not include a display, keyboard, or other input/output components.

Furthermore, it should be noted that any of the methods described herein can include an additional step of providing a system comprising distinct software modules embodied on a tangible computer readable recordable storage medium. All the modules (or any subset thereof) can be on the same medium, or each can be on a different medium, for example. The modules can include any or all of the components shown in the figures. In one or more embodiments, the modules include a practice management system module, a claims engine module, an issuer platform module, and an acquirer platform module. The method steps can then be carried out using the distinct software modules (or sub-modules implementing functionality within the system, engine, or platforms as described in FIG. 6) of the system, as described above, executing on one or more hardware processors. For example, each platform, system, or engine in FIG. 6 could execute on a different hardware processor of a different server or other computer; some platforms, systems, or engines could be on the same server or other computer as others, and so on. Further, a computer program product can include a tangible computer-readable storage medium with code adapted to be executed to carry out one or more method steps described herein, including the provision of the system with the distinct software modules.

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
facilitating authorization, clearing and settlement for a pre-payment portion of a transaction conducted with a provider using a payment device having an account number;
facilitating adjudication of a claim pertaining to said transaction, said adjudication resulting in a payer portion and a remaining patient portion;
facilitating storage of transaction information pertaining to said transaction, by an issuer of said payment device;
facilitating matching, by said issuer of said payment device, of: (i) a payment advice associated with said adjudication of said claim with (ii) said transaction information stored in said step of facilitating storage; and
responsive to said matching, facilitating said issuer controlling initiation of authorization, clearing, and settlement of said remaining patient portion.

2. The method of claim 1, further comprising facilitating said issuer communicating with a holder of said payment device to offer said holder an opportunity for opt-out, prior to said issuer initiating said authorization, clearing, and settlement of said remaining patient portion.

3. The method of claim 2, wherein said issuer controlling said initiation comprises:
assigning a pseudo account number by mapping said account number; and
facilitating said provider initiating a supplemental transaction, using said pseudo account number, to authorize, clear, and settle said remaining patient portion.

4. The method of claim 3, wherein said step of facilitating said provider initiating said supplemental transaction comprises sending said provider a supplemental transaction message comprising said pseudo account number.

5. The method of claim 2, wherein said issuer controlling said initiation comprises:
responsive to said matching, facilitating assigning a pseudo account number by mapping said account number; and
facilitating said issuer of said payment device initiating a supplemental transaction, using said pseudo account number, to authorize said remaining patient portion.

6. The method of claim 5, further comprising sending said provider a supplemental transaction message comprising said pseudo account number and an indication that said remaining patient portion has already been authorized.

7. The method of claim 2, wherein said issuer controlling said initiation comprises:
responsive to said matching, facilitating issuer-based clearing and settlement of said remaining patient portion.

8. The method of claim 7, wherein said issuer-based clearing and settlement of said remaining patient portion occurs without any further action required by said provider.

9. The method of claim 1, further comprising repeating said steps of facilitating authorization, facilitating adjudication, facilitating storage, facilitating matching, and facilitating issuer control for an additional transaction conducted using an additional payment device issued by a different issuer and carrying a different brand, wherein said steps of facilitating authorization, facilitating adjudication, facilitating storage, facilitating matching, and facilitating issuer control, and said repeated steps, are performed in association with a single payment network operator.

10. The method of claim 1, further comprising the additional step of:
providing a system, wherein said system comprises distinct software modules, each of said distinct software modules being embodied on at least one tangible computer-readable recordable storage medium, and wherein said distinct software modules comprise a practice management system module, a claims engine module, an issuer platform module, and an acquirer platform module;
wherein:
said step of facilitating authorization, clearing and settlement for said pre-payment portion is carried out by:
said practice management system module, executing on a first hardware processor, communicating with said acquirer platform module, executing on a second hardware processor; and
said acquirer platform module, executing on said second hardware processor, communicating, via a payment network, with said issuer platform module, executing on a third hardware processor;
said step of facilitating adjudication of said claim is carried out by said claims engine module, executing on a fourth hardware processor;
said step of facilitating storage of said transaction information is carried out by storing said transaction information in a transaction data store associated with issuer platform module;
said step of facilitating said matching is carried out by said issuer platform module, executing on said third hardware processor; and
said step of, responsive to said matching, facilitating said issuer controlling said initiation, is carried out by said issuer platform module, executing on said third hardware processor.

11. A method comprising the steps of:
facilitating authorization, clearing and settlement for a pre-payment portion of a transaction conducted with a provider using a payment device having an account number;
facilitating adjudication of a claim pertaining to said transaction, said adjudication resulting in a payer portion and a remaining patient portion;
facilitating storage of transaction information pertaining to said transaction, by an issuer of said payment device;
facilitating matching, by said issuer of said payment device, of: (i) a payment advice associated with said adjudication of said claim with (ii) said transaction information stored in said step of facilitating storage;
responsive to said matching, facilitating said issuer communicating with a holder of said payment device to offer said holder an opportunity for opt-out, prior to settlement of said remaining patient portion.

12. The method of claim 11, further comprising repeating said steps of facilitating authorization, facilitating adjudication, facilitating storage, facilitating matching, and facilitating issuer communication for an additional transaction conducted using an additional payment device issued by a different issuer and carrying a different brand, wherein said steps of facilitating authorization, facilitating adjudication, facilitating storage, facilitating matching, and facilitating issuer communication, and said repeated steps, are performed in association with a single payment network operator.

13. The method of claim 11, further comprising the additional step of:
providing a system, wherein said system comprises distinct software modules, each of said distinct software modules being embodied on at least one tangible computer-readable recordable storage medium, and wherein said distinct software modules comprise a practice management system module, a claims engine module, an issuer platform module, and an acquirer platform module;
wherein:
said step of facilitating authorization, clearing and settlement for said pre-payment portion is carried out by:
said practice management system module, executing on a first hardware processor, communicating with said acquirer platform module, executing on a second hardware processor; and
said acquirer platform module, executing on said second hardware processor, communicating, via a payment network, with said issuer platform module, executing on a third hardware processor;
said step of facilitating adjudication of said claim is carried out by said claims engine module, executing on a fourth hardware processor;
said step of facilitating storage of said transaction information is carried out by storing said transaction information in a transaction data store associated with issuer platform module;
said step of facilitating said matching is carried out by said issuer platform module, executing on said third hardware processor; and
said step of, responsive to said matching, facilitating said issuer communicating with said holder of said payment device, is carried out based upon customer information in a customer data store associated with said issuer platform module.

14. A system comprising:
a memory; and
at least one processor, coupled to said memory, and operative to:
facilitate authorization, clearing and settlement for a pre-payment portion of a transaction conducted with a provider using a payment device having an account number;
facilitate adjudication of a claim pertaining to said transaction, said adjudication resulting in a payer portion and a remaining patient portion;
facilitate storage of transaction information pertaining to said transaction, by an issuer of said payment device;
facilitate matching, by said issuer of said payment device, of: (i) a payment advice associated with said adjudication of said claim with (ii) said stored transaction information; and
responsive to said matching, facilitate said issuer controlling initiation of authorization, clearing, and settlement of said remaining patient portion.

15. The system of claim 14, wherein said processor is further operative to facilitate said issuer communicating with a holder of said payment device to offer said holder an opportunity for opt-out, prior to said issuer initiating said authorization, clearing, and settlement of said remaining patient portion.

16. The system of claim 15, wherein said processor is operative to facilitate said issuer controlling said initiation by being operative to:
assign a pseudo account number by mapping said account number; and
facilitate said provider initiating a supplemental transaction, using said pseudo account number, to authorize, clear, and settle said remaining patient portion.

17. The system of claim 16, wherein said processor is operative to facilitate said provider initiating said supplemental transaction by being operative to facilitate sending said provider a supplemental transaction message comprising said pseudo account number.

18. The system of claim 15, wherein said processor is operative to facilitate said issuer controlling said initiation by being operative to:
responsive to said matching, facilitate assigning a pseudo account number by mapping said account number; and
facilitate said issuer of said payment device initiating a supplemental transaction, using said pseudo account number, to authorize, clear, and settle said remaining patient portion.

19. The system of claim 18, wherein said processor is operative to facilitate sending said provider a supplemental transaction message comprising said pseudo account number and an indication that said remaining patient portion has already been authorized.

20. The system of claim 15, wherein said processor is operative to facilitate said issuer controlling said initiation by being operative to:
responsive to said matching, facilitate issuer-based clearing and settlement of said remaining patient portion.

21. The system of claim 20, wherein said processor is operative such that said issuer-based clearing and settlement of said remaining patient portion occurs without any further action required by said provider.

22. The system of claim 14, wherein said at least one processor comprises a first processor, a second processor, a third processor, and a fourth processor, further comprising:
a transaction data store;
a customer data store having customer information;
a payment network; and
distinct software modules, each of said distinct software modules being embodied on at least one tangible computer-readable recordable storage medium, and wherein said distinct software modules comprise a practice management system module, a claims engine module, an issuer platform module, and an acquirer platform module;
wherein:
said first, second, and third hardware processors are operative to facilitate said authorization, clearing and settlement for said pre-payment portion by:
said first hardware processor, executing said practice management system module, communicating with said second hardware processor, executing said acquirer platform module; and
said second hardware processor, executing said acquirer platform module, communicating, via said payment network, with said third hardware processor executing said issuer platform module;
said fourth hardware processor facilitates said adjudication of said claim by executing said claims engine module;
said third hardware processor facilitates said storage of said transaction information by storing said transaction information in said transaction data store, said transaction data store being associated with said issuer platform module;
said third hardware processor facilitates said matching by executing said issuer platform module; and
responsive to said matching, said third hardware processor facilitates said issuer communicating with said holder of said payment device, based upon said customer information in said customer data store, said customer data store being associated with said issuer platform module.

23. A system comprising:
means for facilitating authorization, clearing and settlement for a pre-payment portion of a transaction conducted with a provider using a payment device having an account number;
means for facilitating adjudication of a claim pertaining to said transaction, said adjudication resulting in a payer portion and a remaining patient portion;
means for facilitating storage of transaction information pertaining to said transaction, by an issuer of said payment device;
means for facilitating matching, by said issuer of said payment device, of: (i) a payment advice associated with said adjudication of said claim with (ii) said transaction information stored in said step of facilitating storage; and
means for, responsive to said matching, facilitating said issuer controlling initiation of authorization, clearing, and settlement of said remaining patient portion.

24. The system of claim 23, wherein said means for facilitating said issuer controlling said initiation comprise:
means for, responsive to said matching, facilitating assigning a pseudo account number by mapping said account number; and
means for facilitating said issuer of said payment device initiating a supplemental transaction, using said pseudo account number, to authorize said remaining patient portion.

25. The system of claim 23, wherein said means for facilitating said issuer controlling said initiation comprise:
means for, responsive to said matching, facilitating issuer-based clearing and settlement of said remaining patient portion.
